(19) United States
(12) Patent Application Publication
(10) Pub. No.: US 2010/0101365 A1
(43) Pub. Date: Apr. 29, 2010

(54) FLYWHEEL STRUCTURE OF ENERGY STORAGE APPARATUS

(75) Inventors: Se-Yong JUNG, Daejeon (KR); Young-Hee HAN, Daejeon (KR); Jeong-Phil LEE, Daejeon (KR); Byung-Jun PARK, Daejeon (KR); Byeong-Cheol PARK, Daejeon (KR); Tae-Hyun SUNG, Daejeon (KR)

Correspondence Address: THE NATH LAW GROUP, 112 South West Street, Alexandria, VA, 22314, US

(73) Assignee: KOREA ELECTRIC POWER CORPORATION, Gangnam-gu (KR)

(21) Appl. No.: 12/566,967

(22) Filed: Sep. 25, 2009

(30) Foreign Application Priority Data
Oct. 28, 2008 (KR) 10-2008-0105961

(51) Int. Cl. F16F 15/315

(52) U.S. Cl. 74/572.21

(57) ABSTRACT

Provided is a flywheel structure of an apparatus for storing energy (particularly electric power), and more particularly, to a flywheel structure of an energy storage apparatus, which allows stable operation since upper and lower thrust collars are installed on an upper and lower faces of a rotor or a hub of the flywheel, respectively and the system thus can be balanced after assembly is completed in a state that all parts including the thrust collars are assembled and which can control vibration effectively since axial displacement is controlled at upper and lower sides of the center of gravity. To this end, the present invention provides a flywheel structure of an energy storage apparatus comprising a central shaft connected to a bearing for restricting a radial direction and an electric motor, a rotor of a high strength for storing rotational energy, a hub for connecting the central shaft and the rotor, and a thrust collar mounted on the central shaft, wherein upper and lower thrust collars are installed on upper and lower face of the rotor or the hub, respectively.

### CROSS-REFERENCE TO RELATED APPLICATION

This application claims priority to and the benefit of Korea Patent Application No. 2008-0105961, filed on Oct. 28, 2008, the disclosure of which is incorporated herein by its entirety.

### BACKGROUND OF THE INVENTION

1. Field of the Invention

The present invention relates to a flywheel structure of an apparatus for storing energy (particularly electric power), and more particularly, to a flywheel structure of an energy storage apparatus, which allows stable operation since upper and lower thrust collars are installed on an upper and lower faces of a rotor or a hub of the flywheel respectively and the system thus can be balanced after assembly is completed in a state that all parts including the thrust collars are assembled and which can control vibration effectively since axial displacement is controlled at upper and lower sides of the center of gravity.

2. Description of Related Art

In general, a flywheel is one of a rotating body and is a device for storing energy using an inertial force upon rotation. The flywheel has an advantage that since the stored energy is proportional to square of the rotational speed, the faster the flywheel rotates the more energy corresponding to the square of the rotational speed is stored.

A contactless electromagnetic bearing is used in order to rotate the flywheel at a high speed for increasing the stored energy or reduce rotational loss due to friction. When the flywheel provided with this electromagnetic bearing rotates at a high speed, vibration is generated due to physical properties of the flywheel and radial vibration and axial vibration of the flywheel are controlled by the electromagnetic bearing in order to reduce this vibration maximally.

The flywheel of the conventional energy storage apparatus will be described with reference to FIG. 5. FIG. 5 is a sectional view illustrating a conventional structure of a flywheel 5 provided with a thrust collar 4. A central shaft 1 connected to an electromagnetic bearing and an electric motor reduces radial and axial vibrations of the flywheel 5 and transfer motive power for energy storing. A hub mounted in on the central shaft 1 connects the central shaft 1 and a rotor 2 and the rotor 2 is made of high strength material and stores inertial energy upon high speed rotation.

As described above, the thrust bearing in the conventional electromagnetic flywheel 5 consists of the thrust collar 4, which reduces an axial vibration generated in a direction of the central shaft 1 and is mounted on the central shaft 1, and a thrust coil, and the thrust coil is placed adjacent to upper and lower faces of the thrust collar 4 to induce, when the axial vibration is generated, stable rotation of the central shaft 1 by applying magnetic force to the upper and lower faces of the thrust collar 4 and thus making attractive force acting from the upper side and lower side.

This conventional flywheel 5 has problems as follows.

First, in order to reduce unbalance in mass of the flywheel, mass is added to or removed from a certain portion of the flywheel through balancing when manufacture of the flywheel is completed, thereby minimizing the unbalance. However, the conventional flywheel 5 has, due to its structure, a shape in that the thrust collar 4 is protruded from the central shaft 1, and it is thus impossible to assemble the system with the thrust collar 4 being assembled to the central shaft 1 because of the thrust coil placed at a lower face of the thrust collar 4. Therefore, the flywheel 5, yet to be assembled with the thrust collar 4 and the thrust collar 4 are balanced separately. After that, the flywheel 5, yet to be assembled with the thrust collar 4 is first assembled to the system and the thrust coil placed at the lower face of the thrust collar 4 is then assembled. Then, the thrust collar 4 is assembled, thereby assembling the rest of the system. At this time, since the balancing of the flywheel is not performed in the state that the thrust collar 4 is assembled, generation of large unbalance is unavoidable.

Second, in the flywheel 5, most of the mass is concentrated into the rotor 2 for the energy storing of the rotor 2, and the center of gravity is placed in the center of the rotor 2. However, since the thrust collar 4 of this flywheel is mounted only on one side, i.e. the upper side or the lower side of the rotor 2, when the flywheel 5 is tilted as shown in FIG. 4, the flywheel is further tilted when magnetic force is applied to the thrust collar 4, which causes instability.

Third, as shown in FIGS. 5 and 6, the thrust collar 4 of the conventional flywheel 5 is mounted far from the center of gravity, and this amplifies the tilting, causing further instability.

Fourth, a length of the central shaft 1 should be lengthened in order to mount the thrust collar 4 on the central shaft 1 or the rotational body and ensure mounting space for the thrust coil, this can be a cause for instability by generating a bending mode within operation range.

### SUMMARY OF THE INVENTION

An embodiment of the present invention is directed to providing a flywheel structure of an energy storage apparatus, which allows stable operation since upper and lower thrust collars are installed on an upper and lower faces of a rotor or a hub of the flywheel, respectively and the system thus can be balanced after assembly is completed in a state that all parts including the thrust collars are assembled, and which can control vibration effectively when the flywheel is tilted, since axial displacement is controlled at upper and lower sides of the center of gravity, and in which a bending mode is not generated within operation range of the flywheel since it is not necessary to lengthen a length of a central shaft.

To achieve the object of the present invention, the present invention provides a flywheel structure of an energy storage apparatus comprising a central shaft connected to a bearing for restricting a radial direction and an electric motor, a rotor of a high strength for storing rotational energy, a hub for connecting the central shaft and the rotor, and a thrust collar mounted on the central shaft, wherein upper and lower thrust collars are installed on upper and lower face of the rotor or the hub, respectively.

As described above, the upper and lower thrust collars are installed on the upper and lower faces of the rotor or the hub of the flywheel of an energy storage apparatus in accordance with an embodiment of the present invention, respectively. Therefore, it is possible to perform stable operation since it is possible to balance the system after completing assembly with all parts including the thrust collar being completely assembled. Also, it is possible to control vibration effectively since an axial displacement of the central shaft 1 is controlled in upper and lower sides of the center of gravity of the flywheel. Further, it is not necessary to lengthen the length of the central shaft for mounting the thrust collar and ensuring the space for the thrust coil. Therefore, the bending mode is not generated within the operation range of the flywheel, thereby capable of reducing instability during rotation.

### BRIEF DESCRIPTION OF THE DRAWINGS

FIG. 1 is a sectional view illustrating a flywheel of an energy storage apparatus in accordance with an embodiment of the present invention.

FIG. 2 is a sectional view illustrating control direction of the thrust collars when the flywheel is tilted during rotation.

FIGS. 3 and 4 are sectional views illustrating flywheels of an energy storage apparatus in accordance with other embodiments of the present invention.

FIG. 5 is a sectional view illustrating a flywheel of a conventional energy storage apparatus.

FIG. 6 is a sectional view corresponding to FIG. 2 and illustrating control direction of the thrust collar when the flywheel is leaned during rotation.

### DESCRIPTION OF SPECIFIC EMBODIMENTS

The advantages, features and aspects of the invention will become apparent from the following description of the embodiments with reference to the accompanying drawings, which is set forth hereinafter.

In the drawings, same reference symbol will be given to the same part of the conventional art.

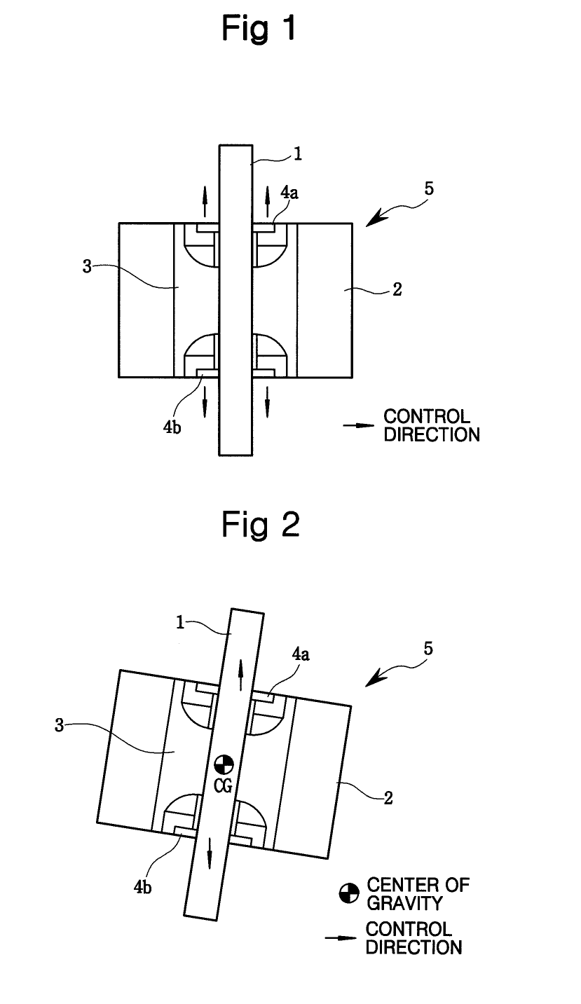

FIG. 1 is a sectional view illustrating a flywheel of an energy storage apparatus in accordance with an embodiment of the present invention.

The flywheel structure of an energy storage apparatus in accordance with an embodiment of the present invention includes a central shaft 1 connected to a bearing for restricting the radial direction and an electric motor, a rotor 2 of a high strength for storing rotational energy, a hub for connecting the central shaft 1 and the rotor, and a thrust collar 4 mounted on an upper portion of the central shaft 1, wherein upper and lower thrust collars 4a, 4b are installed on upper and lower face of the rotor 2 or the hub 3, respectively.

Also, each of the upper and lower thrust collar 4a, 4b are provided with a thrust coil which functions as a thrust bearing stator capable of applying magnetic force thereto.

Meanwhile, as shown in FIG. 2, the upper and lower thrust collars 4a, 4b are installed on the upper and lower faces of the rotor 2 or the hub 3 of the flywheel 5 of an energy storage apparatus in accordance with an embodiment of the present invention, respectively. Therefore, it possible to perform stable operation since it is possible to balance the system after completing assembly with all parts including the thrust collar being completely assembled.

Also, the flywheel 5 of an energy storage apparatus in accordance with an embodiment of the present invention can control vibration effectively since an axial displacement of the central shaft 1 is controlled, as indicated by arrows, in upper and lower sides of the upper and lower thrust collars 4a, 4b placed upper and lower sides of the center of gravity CG when the flywheel 5 is tilted due to vibrations caused during rotation.

That is to say, the upper and lower thrust collars 4a, 4b are designed so that attraction force is applied in the upper thrust collar 4a to move the flywheel 5 to upward direction of the central shaft 1 when the flywheel 5 is moved to downward direction of the central shaft 1, and the attraction force is applied in the lower thrust collar 4b to move the flywheel 5 to downward direction of the central shaft 1 when the flywheel 5 is moved to upward direction of the central shaft 1.

Also, the length of the central shaft 1 is not lengthened for ensuring the space for the thrust coil as the upper and lower thrust collars 4a, 4b are mounted on the upper and lower faces of the hub 3 when mounting the upper and lower thrust collars 4a, 4b, and the bending mode is therefore not generated within the operation range of the flywheel 5.

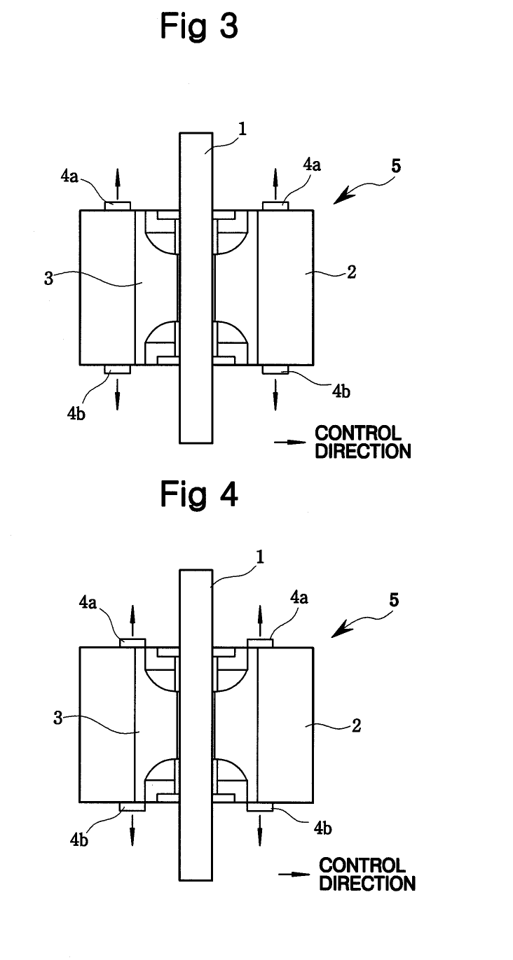

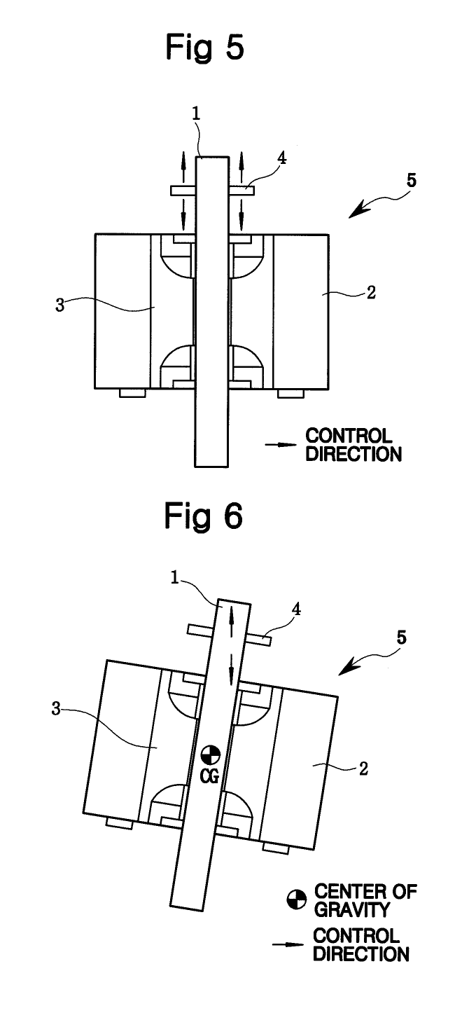

Meanwhile, FIGS. 3 and 4 are sectional views illustrating the flywheels 5 in accordance with other embodiments of the present invention, in which the upper and lower thrust collars 4a, 4b are mounted on the upper and lower faces of the rotor or mounted on the upper and lower faces of the rotor 2 and the hub 3 across them. These flywheels 5 in accordance with other embodiment of the present invention have the same function and operation as the embodiment of FIG. 1.

Also, the upper and lower thrust collars 4a, 4b are protruded from the rotor 2 and the hub 3, but if necessary, may be inserted into the rotor 2 and the hub 3 as shown in FIG. 1.

While the present invention has been described with respect to the specific embodiments, it will be apparent to those skilled in the art that various changes and modifications may be made without departing from the spirit and scope of the invention as defined in the following claims.

What is claimed is:

1. A flywheel structure of an energy store apparatus comprising a central shaft connected to a bearing for restricting a radial direction and an electric motor, a rotor of a high strength for storing rotational energy, a hub for connecting the central shaft and the rotor, and a thrust collar mounted on an upper portion of the central shaft, wherein upper and lower thrust collars are installed on upper and lower face of the rotor or the hub, respectively.

2. The flywheel structure of an energy store apparatus of claim 1, wherein the upper and lower thrust collars are installed on the upper and lower faces of the rotor or the hub to protrude no part from the central shaft and enable assembly of other system with all parts including the thrust collar being completely assembled.

3. The flywheel structure of an energy store apparatus of claim 1, wherein the upper and lower thrust collars are designed so that attraction force is applied in the upper thrust collar to move the flywheel to upward direction of the central shaft when the flywheel is moved to downward direction of the central shaft and the attraction force is applied in the lower thrust collar to move the flywheel to downward direction of the central shaft when the flywheel is moved to upward direction of the central shaft.
